(19) United States
(12) Patent Application Publication
(10) Pub. No.: US 2006/0157979 A1
(43) Pub. Date: Jul. 20, 2006

(54) Coupling member for use in a system with flowing fluid comprising integral locking tonques for engaging wing .e.g. an annular groove

(75) Inventor: Egil Pedersen, Raufoss (NO)

Correspondence Address: OSHA LIANG L.L.P., 1221 MCKINNEY STREET, SUITE 2800, HOUSTON, TX, 77010, US

(73) Assignee: Raufoss United SA, Raufoss (NO)

(21) Appl. No.: 10/533,178

(22) PCT Filed: Oct. 31, 2003
(86) PCT No.: PCT/NO03/00366

§ 371 Date: Nov. 14, 2005

(30) Foreign Application Priority Data
Oct. 31, 2002 (NO) 20025234

(51) Int. Cl. F16L 39/00

(52) U.S. Cl. 285/319

(57) ABSTRACT

Coupling part for use in a system with flowing fluid, with an integral male part (1) to be sealingly mounted and retained upon aksial insertion into an adapted female part on another coupling part, the female part has at least one internal annular groove or a step for locking the male part. The male part (1) has, for engaging with the annular groove or grooves, steps, integral locking tongues (2, 3), respectively. The free ends of the locking tongues are pointing oppositely of the direction of insertion for the male part (1) into female part, and all the locking tongues are projecting slanting outwardly or have hooks projecting outwardly. The male part of the female part may be provided with at least one sealing element.

The present invention relates to a coupling part for use in a system for flowing fluid, comprising a male part to be sealingly mounted and retained in an adapted female part on another coupling part, the male and female parts being provided with at least one sealing element.

In known solutions for locking systems for male and female parts, the locking element often comprises a separat ring. The ring may be placed on either the male or the female part, while the other part comprises a locking groove. The ring is compressed or expanded when the male part is inserted into the female part, before it slips into place in the locking groove.

E.g. in pneumatic brake pipe arrangements in large vehicles, coupling parts with nipples for the pipes are used, the coupling parts being provided with male parts for connecting these to openings in female parts on another coupling part in a sealing manner. The nipples may have external circumferential grooves, onto which the pipes are pressed and retained in a sealing manner. Opposite of the nipples the coupling parts may have a male part with sealing elements and locking rings which are to retain the coupling parts in female parts having an internal groove for a locking ring. A common type of locking ring is a split ring, possibly with a chamfered external edge in order to facilitate insertion into the female part. As sealing elements are commonly used O-rings, which may be extended in order to be pulled onto the male parts and placed in the ring grooves in these, or which are inserted into the female parts and placed in the internal grooves therein.

Hence, the locking rings are separate parts, which are mounted on the male parts or in the female parts before these are connected together.

Coupling parts of this type have for a long time been produced from metal, in particular brass, and the production method has been turning. From price related reasons it has been desirable to produce coupling parts by injection moulding of plastic, in order to reduce the cost of materials and avoid finishing. Besides, it is desirable to avoid separate locking rings.

One requirement for rational moulding is that the casting mould parts that are used, including a core which produces a throughgoing channel after the moulding, may be used for a large number of coupling parts, and hence, the coupling parts need to be able to be disengaged from the mould parts without the mould parts having to be destroyed. The coupling part may e.g. be moulded as a purely rotational element by use of a removable core and a two-part external mould.

By the present invention a coupling part has been provided, having a male part which makes it possible to mould the coupling part with integral locking tongues, in such a way that use of a separat locking ring is avoided, the free ends of the locking tongues are pointing oppositely of the direction of insertion for the male part into a female part. Each locking tongue has an outwardly directed hook at the free end, for engaging with an inner groove or a stepping in the female part.

The production is rational by not requiring production and assembling of separate locking rings. Besides, the danger of the locking rings being lost or missing or incorrectly put on is avoided.

During load, by internal pressure in the system of which the male part is a part, the locking tongues will be exposed to pressure load in the longitudinal direction.

For moulding of the coupling part comprising the male part, two or more external mould parts and a core may be used. The external mould parts may have a ribbed structure meeting the core and hence delimiting two or more locking tongues on the male part. When the mould parts are removed from the moulded male part, openings which delimit the locking tongues have been made in the male part.

Locking tongues made by openings as described above need to be directed towards the external mould parts. By use of a two-part external mould the locking tongues may be made in two sectors of the circumference of the male part. Locking tongues between these sectors may be produced by being connected to the remainder of the male part through two planar bridges which are mainly parallel to the inside of a respective locking tongue which is in radial distance outwardly of each bridge.

A coupling part according to the invention may have different types of transitions to other parts of the system. The end of the coupling part which is opposite of the male part may e.g. be integral with or mounted in a sleeve provided with external threads, it may be made as a nipple for mounting of a pipe, it may be made as a corresponding male part for insertion into another female part, and the coupling part may form a T-piece with three male parts according to the invention, for insertion into three female parts. There are no limitations with respect to the design of this end of the coupling part, except that flow-through is to be made possible.

The invention will be further explained in the following by means of an example of embodiment, with reference to the appended drawings.

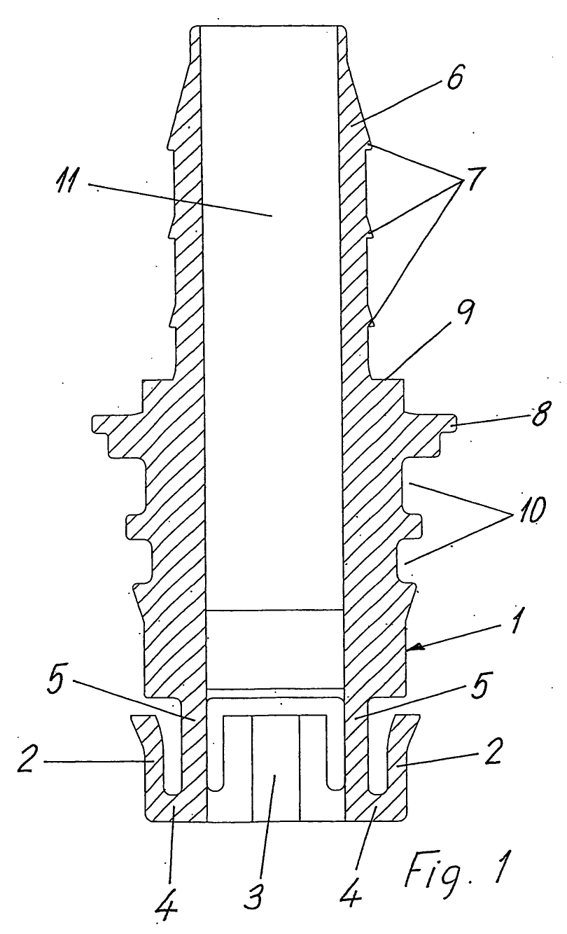

FIG. 1 shows an axial section through a coupling part according to the invention.

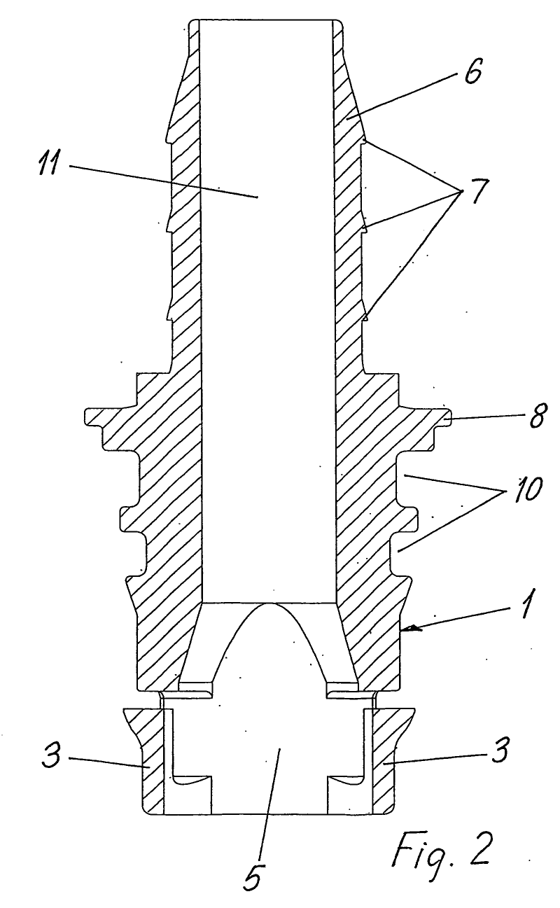

FIG. 2 shows another axial section through the same coupling part according to the invention, at 90° to the first axial section.

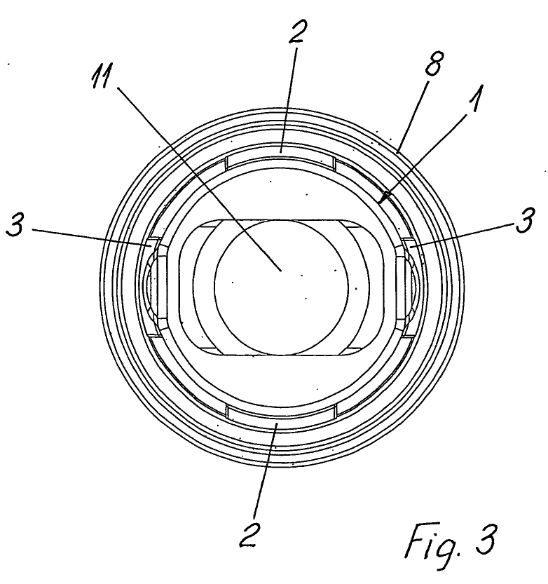

FIG. 3 shows an end view of the coupling part towards the end on which the male part is situated.

In the shown example the coupling part has a nipple 6 for mounting of a pipe on the end opposite of a male part 1. As mentioned, this end of the coupling part may be designed in many other ways.

The shown embodiment of the coupling part according to the invention comprises a male part 1 for insertion into an adapted female part and locking of the male part 1 in the female part. For such a locking the male part 1 has locking tongues 2, 3 pointing oppositely of the direction of insertion of the male part 1 into a female part, as the female part is assumed to have a corresponding groove or a stepping with which the locking tongues will engage.

The male part 1 also has grooves 10 for sealing elements, for bearing against an adapted surface inside the female part.

Besides, the male part 1 has in the shown embodiment a flange 8, which may cooperate with an adapted portion in the female part in order to center the coupling part therein.

A shoulder 9 on the male part 1 forms a stop surface for a pipe inserted onto the nipple 6. The nipple 6 is shown with circumferential ribs 7 for retaining the pipe.

The shown embodiment of the coupling part may be moulded by use of a two-part external casting mould, i.e. a casting mould with two mould parts which may be moved radially to and from each other. The male part 1 has four locking tongues, two locking tongues 2 connected to a respective bridge portion 5 through wide portions of a ring 4, as it appears from FIG. 1, and two locking tongues 3 projecting directly from a respective narrower portion of the ring 4, as it appears from FIG. 2. The bridge portions 5 are planar and mutually parallel, and determines the direction of movement of the mould parts, which is perpendicular to the section plane in FIG. 1 and parallel to the section plane in FIG. 2.

In the shown example each locking tongue 2, 3 is shown with an outward bend. Alternatively, each locking tongue 2, 3 may protrude slanting outwardly.

As it appears from FIGS. 2 and 3, the flow-through channel 11 is designed so that it permits extracting of a mould core from the channel after the moulding. As it best appears from FIG. 3, the cross section of the channel in one end is approximately oval, which is due to the wide and narrow portions of the ring 4.

The most important is that the male part 1 has integral locking tongues 2, 3 pointing oppositely of the direction of insertion into a female part, whereby the locking tongues 2, 3 are pressure loaded due to the pressure in a fluid in the system. The coupling part may be made with more than four locking tongues 2, 3, and still be mouldable, by using more than two external mould parts, which e.g. may be moved radially in several directions.

The coupling part according to the invention may be moulded both of metal and plastic. Plastic is preferred from cost considerations.

In principle, the flowing fluid may be any liquid or gas.

1. A coupling part for use in a system with flowing fluid, having an integral male part to be sealingly mounted and retained upon axial insertion into an adapted female part on another coupling part, the female part having at least one internal annular groove or a stepping for locking the male part,
wherein the integral male part has a stepping and integral locking tongues for engaging with the annular groove or grooves of the female part, the locking tongues have free ends pointing in the opposite direction of the insertion of the male part into the female part, and all the locking tongues project slanting outwardly or have hooks projecting outwardly.

2. A coupling part as specified in claim 1, wherein all the locking tongues are integral to an end portion of the male part, this end portion being connected to the remainder of the male part through two planar bridge portions which are parallel to the inside of their respective locking tongues that are situated in a radial distance outwardly from each bridge; other locking tongues are situated between the two locking tongues along a circumferential direction, whereby the use of a two-part external mould is made possible.

3. A coupling part as specified in claim 1, wherein all the locking tongues are situated at a free end portion of the male part, whereby a sleeve tool may be applied onto the end portion to compress the locking tongues in order to disengage the male part from the female part.
